(19) United States
(12) Patent Application Publication
(10) Pub. No.: US 2025/0161914 A1
(43) Pub. Date: May 22, 2025

(54) A METHOD FOR PREPARING METAL-ORGANIC FRAMEWORK USING MICROWAVE SYNTHESIS AND METAL-ORGANIC FRAMEWORK PREPARED THEREFROM

(71) Applicant: PTT EXPLORATION AND PRODUCTION PUBLIC COMPANY LIMITED, Chatuchak Bangkok (TH)

(72) Inventors: Sunatda ARAYACHUKIAT, Bangkok (TH); Kanokwan KONGPATPANICH, Wangchan Rayong (TH); Phakawan THINSOONGNOEN, Wangchan Rayong (TH); Sorawich PIMU, Wangchan Rayong (TH); Kunlanat SRIPHUMRAT, Wangchan Rayong (TH)

(73) Assignee: PTT EXPLORATION AND PRODUCTION PUBLIC COMPANY LIMITED, Chatuchak Bangkok (TH)

(21) Appl. No.: 18/833,587

(22) PCT Filed: Jan. 27, 2023
(86) PCT No.: PCT/IB2023/050707

§ 371 Date: Jul. 26, 2024

(30) Foreign Application Priority Data
Jan. 28, 2022 (TH) 2201000571

(51) Int. Cl. B01J 20/30; B01J 20/22; C08G 63/91

(52) U.S. Cl. CPC B01J 20/3085; B01J 20/226; B01J 20/3071; B01J 20/3078; C08G 63/916

(57) ABSTRACT

A method for preparing metal-organic framework including reacting a mixture having metal precursor and polyethylene terephthalate plastic using microwave synthesis and to metal-organic framework prepared therefrom. The method for preparing metal-organic framework can utilize polyethylene terephthalate plastic waste, thus this can help reduce environmental problems. Additionally, the method can be conveniently performed without complicated and complex steps, as well as save energy in preparation.

### TECHNICAL FIELD

Chemistry related to a method for preparing metal-organic framework using microwave synthesis and metal-organic framework prepared therefrom.

### BACKGROUND OF THE INVENTION

Plastic is a synthetic material which plays an important role in daily life and tends to be increasingly used due to its desirable properties, cheap price and ability to be shaped variously. Thus, at present, plastic products are widely used, resulting in an increase in plastic waste every year. Some of the plastic waste is not self-degradable material or requires hundreds of years to degrade, causing an environmental impact and a plastic waste management problem.

Polyethylene terephthalate (PET) is one of the plastics commonly used for making products, e.g., beverage bottles, packaging boxes or bags, since it has light weight and properties of clearness, stickiness and good tolerance to impact. However, most of polyethylene terephthalate plastic waste produced at present is usually land-filled at the landfill or incinerated in the incinerator. Only a few is recycled since the recycling process is complicated and consists of many steps starting from sorting the product components by plastic types, cleaning, subjecting them to a chemical process to degrade chemical components and forming them into new products. All of these steps not only use a lot of energy, but may also release harmful chemicals to the environment. Therefore, there is an attempt to find an approach to add value to and to maximize the use of polyethylene terephthalate plastic waste in order to reduce an impact to the environment.

One method of utilizing polyethylene terephthalate plastic waste that is currently studied is to utilize it in metal-organic framework synthesis. Since polyethylene terephthalate consists of the main components that can be converted into terephthalic acid (BDC) which can be used as a source of organic linker in metal-organic framework synthesis.

Examples of prior art related to polyethylene terephthalate plastic waste application in metal-organic framework synthesis are as disclosed in the following patent documents.

Chinese patent publication no. CN 110283353 A discloses a method for preparing metal-organic framework by degrading polyester plastic waste such as PET using polyacid. The method comprises the steps of adding a polyacid precursor into a sodium acetate buffer solution, mixing until it becomes clear, and adding the polyester plastic waste fragment and mixing thoroughly using a temperature ranging from 170-190° C. for 60-80 hours, then cooling, washing and drying it to obtain the product of metal-organic framework.

Chinese patent publication no. CN 108676174 A discloses method for preparing metal-organic framework using polyethylene terephthalate plastic waste comprising the solvothermal reaction of Zn(NO)₃)₂·6H₂O and polyethylene terephthalate plastic waste at a temperature of 150° C. for 24 hours, then washing the resulting reaction solution with N-methyl pyrrolidone and methanol solutions, and drying it under vacuum.

US patent publication no. US2021122898 A1 discloses the preparation of metal-organic framework from plastic waste using mechanochemical synthesis in which the preparation was performed by grinding a reaction mixture by controlling the relevant variants, e.g., impact, grinding time, size of grinding ball, temperature range, and pressure, etc.

However, in addition to the aforementioned prior arts, there remains a need for development of polyethylene terephthalate plastic waste utilization in the preparation of metal-organic framework, particularly for development of the method for preparing metal-organic framework from polyethylene terephthalate plastic that can be conveniently performed with simple steps, and save energy and time in preparation.

### SUMMARY OF THE INVENTION

An object of the present invention is to provide a method for preparing metal-organic framework from polyethylene terephthalate plastic waste that can be conveniently performed without complicated and complex steps, and save energy and time in preparation. Particularly, the invention is aimed at developing a method for preparing metal-organic framework from polyethylene terephthalate plastic waste without the terephthalic acid isolation and terephthalic acid purification steps before performing the metal-organic framework synthesis,

Another object of the present invention is to provide a method for preparing metal-organic framework from polyethylene terephthalate plastic waste that can be readily performed with significantly reduced processing time compared to the commonly available method for preparing metal-organic framework from polyethylene terephthalate plastic waste.

In one aspect, the present invention relates to a method for preparing metal-organic framework comprising reacting a mixture comprising metal precursor and polyethylene terephthalate plastic using microwave synthesis.

In another aspect, the present invention relates to a metal-organic framework prepared from the method according to the present invention.

The method for preparing metal-organic framework using microwave synthesis according to the present invention can be performed easily and conveniently with simple steps, save energy, require a short processing time while maintaining high yields. Also, the resulting metal-organic framework product is of similar quality to the metal-organic framework produced from the conventional preparing method using the purified terephthalic acid as a reactant in metal-organic framework synthesis.

### BRIEF DESCRIPTION OF THE DRAWINGS

FIG. 1 is a graph showing the powder X-ray diffraction (PXRD) pattern of the metal-organic framework examples prepared according to the method of the present invention and the PXRD pattern of UiO-66 according to the theory from the database.

FIG. 2 is a graph showing the N₂ adsorption isotherm of the metal-organic framework examples prepared according to the method of the present invention.

FIG. 3 is a graph showing the thermogravimetric analysis (TGA) of the metal-organic framework example prepared from the polyethylene terephthalate plastic samples obtained from 3 different sources.

### DETAILED DESCRIPTION

Any aspects shown herein shall encompass the application to other aspects of the present invention as well, unless stated otherwise.

Technical terms and scientific terms used herein have meanings as understood by a person of ordinary skill in the art, unless determined otherwise.

Throughout the present invention, the term “about” is used to indicate that any values appearing or shown herein may be varied or deviate Such variation or deviation may be caused by equipment error, or method used to determine the values.

The terms “consist(s) of,” “comprise(s),” “contain(s),” and “include(s)” are open-end verbs. For example, any method which “consists of,” “comprises,” “contains” or “includes” one component or multiple components or one step or multiple steps is not limited to only one component or one step or multiple steps or multiple components, but also encompasses components or steps that are not specified.

Tools, devices, methods, materials, or chemicals mentioned herein, unless specified otherwise, mean the tools, devices, methods, materials, or chemicals generally used or practiced by a person skilled in the art.

All components and/or methods disclosed and claimed in the present invention are intended to cover the aspects of the invention obtained from an action, a practice, a modification or a change of any factors which does not require any experiment that is substantially different from the present invention and gives properties and utility and provides the same effect as the aspects of the present invention according to the judgement of a person of ordinary skill in the art, although not specifically stated in the claims. Therefore, substitutions or analogues of the aspects of the present invention and any slight modifications or changes that are clearly apparent to a person of ordinary skill in the art, are considered to be within the spirit, the scope, and concept of the present invention as well.

The term “polyethylene terephthalate plastic” as used herein encompasses any plastics or copolymers that have polyethylene terephthalate as a component, e.g., polyethylene terephthalate plastic that essentially comprises polyethylene terephthalate and may have additives as an additional component, for instance, the polyethylene terephthalate plastic may comprise 80-100 wt %, or 85-100 wt %, or 85-95 wt %, or 80-95 wt %, or 80-90 wt % polyethylene terephthalate compared to the total weight of polyethylene terephthalate plastic, etc. The polyethylene terephthalate plastic according to the present invention can be obtained from different sources, e.g., plastic bottle, plastic fiber, plastic sheet, plastic waste, plastic fragment in the products, etc.

The aforementioned object of the present invention can be accomplished by a method for preparing metal-organic framework characterized as follows.

According to the present invention, the method for preparing metal-organic framework comprises reacting a mixture comprising metal precursor and polyethylene terephthalate plastic using microwave synthesis.

In a specific embodiment, the method for preparing metal-organic framework according to the present invention comprises the steps of:
(i) Providing polyethylene terephthalate plastic which reduced in size;
(ii) Providing a mixture comprising metal precursor and polyethylene terephthalate plastic which reduced in size in the solvent;
(iii) Reacting a mixture of step (ii) using microwave synthesis; and
(iv) Isolating the reaction product derived from step (iii), washing with solvent and drying.

In an alternative embodiment, the method for preparing metal-organic framework according to the present invention may further comprise the step of treating the polyethylene terephthalate plastic powder which reduced in size with microwave under acidic, basic, or neutral conditions before performing step (ii).

More specifically, the method for preparing metal-organic framework may further comprise the step of microwave heating polyethylene terephthalate plastic which reduced in size at a temperature ranging from 150-250° C. for 5-30 minutes before performing step (ii). Preferably, the step of microwave heating polyethylene terephthalate plastic which reduced in size is performed under acidic conditions.

The method for preparing metal-organic framework according to the present invention is performed such that all reactions are one-pot synthesis without the need to isolate and purify the terephthalic acid resulting therefrom prior to the microwave synthesis of metal-organic framework in step (iii).

According to the present invention, the polyethylene terephthalate plastic which reduced in size in step (i) has a particle size of less than 1 cm such as the particle size ranging from 0.01-1 cm or 0.05-1 cm, etc.

In another preferred aspect, the polyethylene terephthalate plastic which reduced in size in step (i) has a particle size of less than 0.05 cm such as the particle size ranging from 0.01-0.05 cm, etc.

The size of polyethylene terephthalate plastic is reduced by grinding, cutting, mechanochemical methods, shearing, tearing or a combination thereof.

According to the present invention, the method for preparing metal-organic framework can be accomplished by reacting a mixture comprising metal precursor and polyethylene terephthalate plastic using microwave synthesis. Preferably, a mixture has a weight ratio of metal precursor to polyethylene terephthalate plastic in a range of 0.2-0.6:1.

In another preferred embodiment, a mixture further comprises acids. Specifically, a mixture in step (ii) comprises metal precursor, polyethylene terephthalate plastic which reduced in size and acids.

Preferably, a mixture has a weight ratio of metal precursor to acids in a range of 0.01-0.03:1.

More preferably, a mixture has a weight ratio of polyethylene terephthalate plastic to acids in a range of 0.02-0.07:1.

Examples of acids usable according to the present invention are nitric acid, hydrochloric acid, sulfuric acid and a mixture thereof, preferably nitric acid.

According to the present invention, the metal precursor can be selected from a group consisting of zirconium (IV), chromium (III), iron (III) salts and a mixture thereof. Preferably, the metal precursor is zirconium (IV) salt.

The zirconium (IV) salts can be selected from a group consisting of zirconium tetrachloride (ZrCl₄), zirconium oxychloride (ZrOCl₂), zirconium oxychloride octahydrate (ZrOCl₂·8H₂O), zirconium acrylate (Zr(CH₂CHCO₂)₄) and a mixture thereof.

According to the present invention, the method for preparing metal-organic framework can be accomplished by microwave synthesis using microwave not lower than 2,450 MHz.

Specifically, the microwave synthesis is performed by heating a mixture using the power ranging from 100-400 watts at a temperature ranging from 80-160° C. for 10-240 minutes. Preferably, the microwave synthesis is performed by heating a mixture using the power ranging from 100-400 watts at a temperature ranging from 100-140° C. for 30-90 minutes, more preferably 45-60 minutes.

As an example, to provide a mixture in step (ii), the solvent that can be selected from a group consisting of dimethylformamide, diethylformamide, water, dimethylsulfoxide and a mixture thereof can be used.

Also, to wash the reaction product in step (iv), the solvent that can be selected from a group consisting of acetone, ethyl acetate, methanol, ethanol and a mixture thereof can be used.

The isolation of the reaction product in step (iv) may be performed by filtering or centrifuging; and the drying in step (iv) may be performed at a temperature ranging from 80-160° C. Preferably, the drying is performed under vacuum.

In a specific embodiment, the polyethylene terephthalate plastic comprises additives, where additives may be selected from a group consisting of dipentyl phthalate (DPP), di-(2-ethylhexyl) adipate (DEHA), di-octyladipate (DOA), diisobutylphthalate (DEP) and a mixture thereof.

In a specific embodiment, the polyethylene terephthalate plastic comprises polyethylene terephthalate ranging from 80-100 wt % of polyethylene terephthalate plastic.

The metal-organic framework prepared from the method according to the present invention can be used as a heavy metal contaminant adsorbent, for instance, it may be used as arsenic, mercury or palladium, etc.

### Example

Now, the invention will be described in more detail with reference to the examples of experiment and the accompanying drawings. However, these examples are not meant to limit the scope of the present invention.

### 1. Method for Preparing Metal-Organic Framework

The metal-organic framework example according to the present invention which is the UiO-66 agent prepared from the used polyethylene terephthalate plastic bottle and zirconium salts to determine the preferred conditions as detailed below.

1) Cut the used polyethylene terephthalate plastic bottle into small pieces of about 0.5-0.7 cm. Then, powder them into particles of less than 425 μm in size to obtain the powdered polyethylene terephthalate plastic samples.

2) Add the specified amount of nitric acid (HNO₃) to the powdered polyethylene terephthalate plastic samples and incubate for 5-30 minutes in a container (EasyPrep Plus vessel).

3) Subject a mixture to the microwave irradiation at a temperature of 150° C. (power ranging from 100-400 watts) for 5 minutes.

4) Add the specified amount of solvent (DMF) and zirconium salts.

5) Subject a mixture to the sonication for 10 minutes and the microwave irradiation (power ranging from 100-400 watts) at a specified temperature and for a specified period of time.

6) Isolate the resulting metal-organic framework by centrifuging and wash with the solvents, DMF and methanol, respectively.

7) Dry the resulting metal-organic framework product at a temperature of 80° C. for 12 hours.

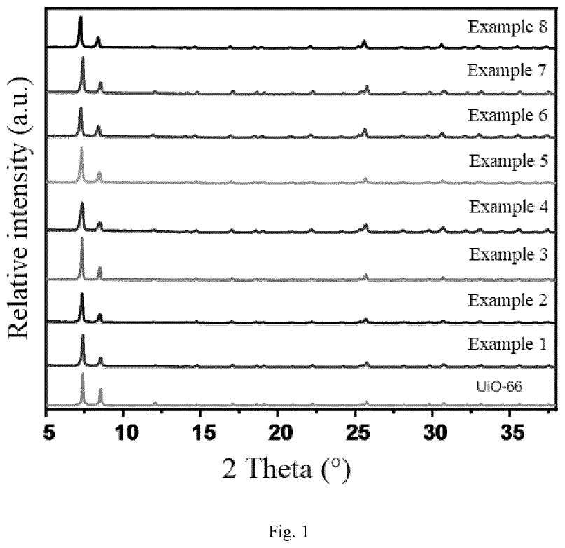

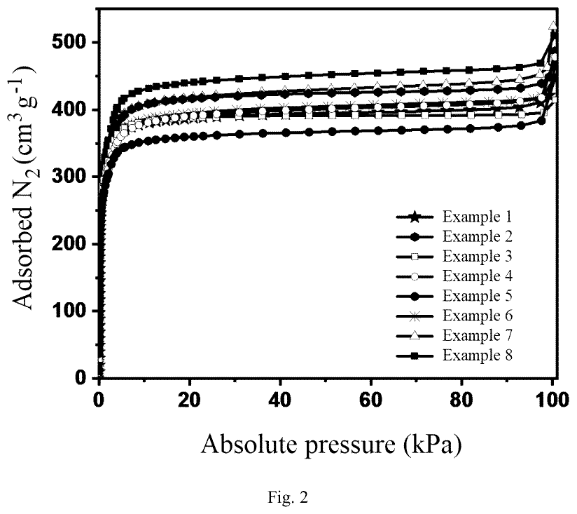

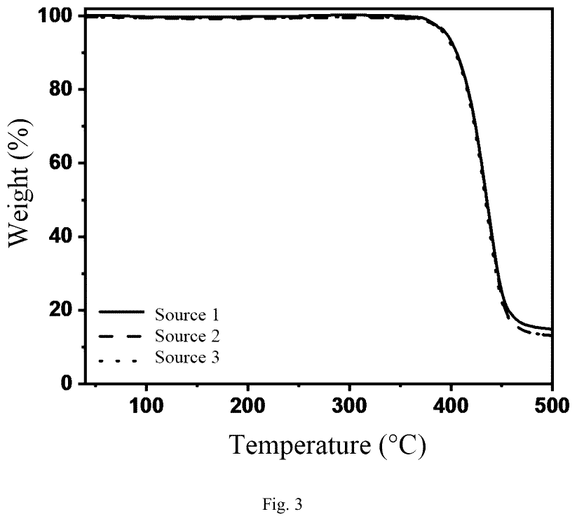

The metal-organic framework product example prepared is further analyzed with the powder X-ray diffraction (PXRD) technique (the result shown in FIG. 1), BET surface area and pore volume and N₂ adsorption isotherm (the result shown in FIG. 2) and the thermogravimetric analysis (TGA) (the result shown in FIG. 3).

### 2. Study on the Preferred Conditions in the Preparation of Metal-Organic Framework

In the present invention, an experiment was carried out to study the effect of acid content, temperature and time in the microwave synthesis on the synthesized metal-organic framework product as detailed below.

### 1) Study on the Effect of Acid Content

The experiment was carried out by preparing the metal-organic framework according to the aforementioned method using a weight ratio of polyethylene terephthalate plastic (PET) to nitric acid (HNO₃) of about 0.02:1, 0.04:1 and 0.07:1 and a weight ratio of zirconium tetrachloride (ZrCl₄) to nitric acid of about 0.01:1 (HNO₃ 10 and 15 ml) and 0.03:1 (HNO₃ 5 ml). The experiment result is shown in FIG. 1 and Table 1.

TABLE 1

| | | | | Metal-organic framework | | |
|---|---|---|---|---|---|---|
| | | | | product | | |
| | | | | | BET | Total |
| | Reactant | | | | surface | pore |
| | ZrCl₄ | PET | HNO₃ ^{b} | % | area | volume |
| Example^{a} | (mg) | (mg) | (mg) | yield ^{c} | (m²/g) | (cm²/g) |
| 1 | 203 | 503 | 5 | 84 | 1518 | 0.70 |
| 2 | 201 | 500 | 10 | 75 | 1615 | 0.73 |
| 3 | 202 | 502 | 15 | 71 | 1540 | 0.64 |

Note:
^{a}The treatment of polyethylene terephthalate plastic with acid using microwave prior to the addition of ZrCl₄ was performed at a temperature 150° C. for 5 minutes; and
The microwave synthesis of metal-organic framework was performed at a temperature 120° C. for 120 minutes;
^{b} HNO₃ has a concentration of 65% and a density of 1.39 g/ml.
^{c} % yield was calculated in comparison with the initial amount of zirconium.

From the experiment result in FIG. 1, it shows that metal-organic framework prepared from the polyethylene terephthalate plastic samples using the method of the present invention (Examples 1-3) have the characteristics corresponding to and consistent with the PXRD pattern of UiO-66 according to the theory from the database.

Furthermore, it was also found that increasing a weight ratio of polyethylene terephthalate plastic to acids from 0.02:1 (Example 3, HNO₃ 15 ml) to 0.04:1 (Example 2, HNO₃ 10 ml) and 0.07:1 (Example 1, HNO₃ 5 ml), respectively, and increasing a weight ratio of zirconium tetrachloride to acids from 0.01:1 (Example 2, HNO₃ 10 ml and Example 3, 15 ml) to 0.03:1 (Example 1, HNO₃ 5 ml) resulted in the increased yields. Over 70% and up to 84% yield can be achieved when using a weight ratio of polyethylene terephthalate plastic to nitric acid of 0.07:1 and a weight ratio of zirconium tetrachloride to nitric acid of 0.03:1 (Example 3).

### 2) Study on the Effect of Temperature and Time in the Microwave Synthesis

The experiment was carried out by preparing the metal-organic framework according to the aforementioned method using a weight ratio of polyethylene terephthalate plastic to nitric acid of 0.04:1 and a weight ratio of zirconium tetrachloride to nitric acid of 0.01:1. The experiment result is shown in FIG. 1 and Table 2.

TABLE 2

| | Metal-organic framework | | | | |
|---|---|---|---|---|---|
| | synthesis conditions | | Metal-organic framework product | | |
| | Temperature | Time | | BET surface area | Total pore volume |
| Example^{a} | (° C.) | (minutes) | % yield ^{b} | (m²/g) | (cm²/g) |
| 2 | 120 | 120 | 75 | 1615 | 0.73 |
| 4 | 100 | 120 | 76 | 1505 | 0.72 |
| 5 | 140 | 120 | 78 | 1363 | 0.68 |
| 6 | 120 | 30 | 50 | 1525 | 0.68 |
| 7 | 120 | 60 | 83 | 1534 | 0.78 |
| 8 | 120 | 90 | 73 | 1659 | 0.78 |

Note:
^{a}The treatment of polyethylene terephthalate plastic with acid using microwave prior to the addition of ZrCl₄ was performed at a temperature 150° C. for 5 minutes; and In the preparation of examples, about 500 g of powdered polyethylene terephthalate plastic examples, about 200 g of zirconium tetrachloride and 10 ml of nitric acid were used.
^{b} % yield was calculated in comparison with the initial amount of zirconium.

FIG. 1 shows that the metal-organic framework prepared from the polyethylene terephthalate plastic samples using the method of the present invention have the characteristics corresponding to and consistent with the PXRD pattern of UiO-66 according to the theory from the database.

From the experiment result in Table 2, it was found that with the same synthesis time (120 minutes), increasing the temperature in the step of microwave synthesis from 100° C. to 120 and 140° C., respectively, resulted in a slightly increased yield where over 75% yield can be achieved (Examples 2, 4 and 5).

At the same synthesis temperature (120° C.), it was found that even with a synthesis time of only 30 minutes, up to 50% yield can be achieved. Increasing a synthesis time from 30 minutes to 60 minutes resulted in a significantly increased yield from 50% to 83%, respectively. However, increasing a synthesis time from 60 minutes to 90 minutes resulted in a decreased % yield from 83% to 73%, respectively.

### 3) Polyethylene Terephthalate Plastic Examples

The experiment was carried out by preparing the metal-organic framework according to the aforementioned method using polyethylene terephthalate plastic bottle waste examples from 3 different sources at a weight ratio of polyethylene terephthalate plastic to nitric acid of 0.04:1 and a weight ratio of zirconium tetrachloride to nitric acid of 0.01:1. The experiment result is shown in FIG. 3.

A graph in FIG. 3 shows the thermogravimetric analysis (TGA) of metal-organic framework prepared from polyethylene terephthalate plastic waste from different sources. In FIG. 3, it was found that the metal-organic framework product prepared according to the method of the present invention using the polyethylene terephthalate plastic samples from the 3 sources showed a degradation corresponding to % weight loss of 85.02% (Source 1), 86.11% (Source 2) and 86.38% (Source 3), respectively, and an incomplete decomposition with the remaining ashes of 14.98% (Source 1), 13.89% (Source 2) and 13.62% (Source 3). From such experiment result, it shows that the metal-organic frameworks from the 3 sources have a similar thermal stability and purity. Therefore, the method for preparing metal-organic framework according to the present invention is an effective method as it can be applied to polyethylene terephthalate plastic waste in general regardless of the sources.

From all of the above experiment results, it shows that the method for preparing metal-organic framework from polyethylene terephthalate plastic waste according to the present invention, not only help reduce environmental problems, but also be able to help shorten the synthesis time while maintaining the high % yield compared to the method commonly available.

### BEST MODE OF THE INVENTION

Best mode of the invention is as described in the detailed description of the invention.

1. A method for preparing metal-organic framework comprising reacting a mixture comprising metal precursor and polyethylene terephthalate plastic using microwave synthesis.

2. The method of claim 1 comprising the steps of:
(i) Providing polyethylene terephthalate plastic which reduced in size;
(ii) Providing a mixture comprising metal precursor and polyethylene terephthalate plastic which reduced in size in the solvent;
(iii) Reacting a mixture of step (ii) using microwave synthesis; and
(iv) Isolating the reaction product derived from step (iii), washing with solvent and drying.

3. The method of claim 2 further comprising the step of microwave heating polyethylene terephthalate plastic which reduced in size at a temperature ranging from 150-250° C. for 5-30 minutes before performing step (ii).

4. The method of claim 3, wherein the step of microwave heating polyethylene terephthalate plastic which reduced in size is performed under acidic conditions.

5. The method of claim 2, wherein polyethylene terephthalate plastic which reduced in size has a particle size of less than 1 cm.

6. The method of claim 5, wherein polyethylene terephthalate plastic which reduced in size has a particle size of less than 0.05 cm.

7. The method of claim 2, wherein the size of polyethylene terephthalate plastic is reduced by grinding, cutting, mechanochemical methods, shearing, tearing or a combination thereof.

8. The method of claim 1, wherein a mixture has a weight ratio of metal precursor to polyethylene terephthalate plastic in a range of 0.2-0.6:1.

9. The method of claim 1, wherein a mixture further comprises acids.

10. The method of claim 9, wherein a mixture has a weight ratio of metal precursor to acids in a range of 0.01-0.03:1.

11. The method of claim 9, wherein a mixture has a weight ratio of polyethylene terephthalate plastic to acids in a range of 0.02-0.07:1.

12. The method of claim 4, wherein acids are nitric acid, hydrochloric acid, sulfuric acid and a mixture thereof.

13. The method of claim 1, wherein metal precursor can be selected from a group consisting of zirconium (IV), chromium (III), iron (III) salts and a mixture thereof.

14. The method of claim 13, wherein zirconium (IV) salts can be selected from a group consisting of zirconium tetrachloride (ZrCl₄), zirconium oxychloride (ZrOCl₂), zirconium oxychloride octahydrate (ZrOCl₂·8H₂O)), zirconium acrylate (Zr(CH₂CHCO₂)₄) and a mixture thereof.

15. The method of claim 1, wherein the microwave synthesis is performed using microwave not lower than 2,450 MHz.

16. The method of claim 1, wherein the microwave synthesis is performed by heating a mixture using the power ranging from 100-400 watts at a temperature ranging from 80-160° C. for 10-240 minutes.

17. The method of claim 16, wherein the microwave synthesis is performed by heating a mixture using the power ranging from 100-400 watts at a temperature ranging from 100-140° C. for 30-90 minutes.

18. The method of claim 2, wherein step (ii) using solvents that can be selected from a group consisting of dimethylformamide, diethylformamide, water, dimethylsulfoxide and a mixture thereof.

19. The method of claim 2, wherein step (iv) using solvents that can be selected from a group consisting of acetone, ethyl acetate, methanol, ethanol and a mixture thereof.

20. The method of claim 2, wherein the reaction product isolation in step (iv) is performed by filtering or centrifuging.

21. The method of claim 2, wherein a drying in step (iv) is performed at a temperature ranging from 80-160° C.

22. The method of claim 1, wherein polyethylene terephthalate plastic comprises additives.

23. The method of claim 22, wherein additives can be selected from a group consisting of dipentyl phthalate (DPP), di-(2-ethylhexyl) adipate (DEHA), di-octyladipate (DOA), diisobutylphthalate (DEP) and a mixture thereof.

24. The method of claim 1, wherein polyethylene terephthalate plastic comprises polyethylene terephthalate ranging from 80-100 wt % of polyethylene terephthalate plastic.

25. The metal-organic framework prepared from the method of claim 1.

26. The metal-organic framework of claim 25 for using as a heavy metal contaminant adsorbent.
